(19) United States
(12) Patent Application Publication
(10) Pub. No.: US 2015/0210049 A1
(43) Pub. Date: Jul. 30, 2015

(54) POLYSTYRENE CLARIFIED BLEND AND METHOD FOR MAKING SAME

(71) Applicant: Klockner Pentaplast of America, Inc., Gordonsville, VA (US)

(72) Inventors: Daryl Means, Troy, OH (US); Edgar R. Rearick, Charlottesville, VA (US)

(21) Appl. No.: 14/605,015

(22) Filed: Jan. 26, 2015

Related U.S. Application Data
(60) Provisional application No. 61/931,341, filed on Jan. 24, 2014.

(51) Int. Cl. B32B 27/30; B29C 47/06; B32B 27/08

(52) U.S. Cl. CPC B32B 27/302; B32B 27/08; B29C 47/065; B32B 2250/02; B32B 2250/246; B32B 2439/70; B29K 2025/06

(57) ABSTRACT

A polystyrene copolymer blend product that that achieve an optimal combination of haze/clarity, strength, toughness/snap, and organoleptic properties. The polystyrene copolymer blend product includes a first layer including about 2 weight percent to about 6 weight percent of a total weight percent of the product, wherein the first layer further includes about 95 weight percent to about 100 weight percent of GPPS or HIPS, and a second layer including about 98 weight percent to about 94 weight percent of the total weight percent of the product, wherein the second layer further includes about 23 weight percent to about 40 weight percent of GPPS, from about 55 weight percent to about 70 weight percent of SBC, and from about 0 weight percent to about 15 weight percent of HIPS.

### CROSS REFERENCE TO PRIOR APPLICATION

This application claims priority to and the benefit thereof from U.S. provisional patent application No. 61/931,341; filed Jan. 24, 2014, titled “Polystyrene Clarified Blend and Method for Making Same,” the entirety of which is hereby incorporate herein by reference.

### FIELD OF DISCLOSURE

The present disclosure relates generally to a polystyrene blend and a polystyrene product, and more specifically it relates to a polystyrene blend and a polystyrene product that achieve an optimal combination of haze/clarity, strength, toughness/snap, and organoleptic properties, where the product may be used in, for example, thermoformed food containers to provide a visually clear package, or the like.

### BACKGROUND OF THE DISCLOSURE

Currently, general purpose polystyrene is frequently used in household products for rigid packing, where transparency is required. However, general purpose polystyrene has low impact resistance and toughness. The thermoplastic blends that address this issue include polystyrene with mixture of other compounds such as nitrile, cyanide, carboxylic acid, and methacrylate.

However, these blends do not have the properties (e.g., impact resistance, transparency, toughness, and organoleptic properties) that are desired in products used in e.g., manufacture of appliance housings, household accessories, medical parts, food packaging, and the like. There exists an unfulfilled need for a polystyrene blend that has an optimal combination of haze/clarity, strength, toughness/snap, and organoleptic properties.

### SUMMARY OF THE DISCLOSURE

According to an aspect of this disclosure, a polystyrene copolymer blend product is provided that includes a first layer including about 2 weight percent to about 6 weight percent of a total weight percent of the product, wherein the first layer further includes about 95 weight percent to about 100 weight percent of GPPS or HIPS; and a second layer including about 98 weight percent to about 94 weight percent of the total weight percent of the product, wherein the second layer further includes about 23 weight percent to about 40 weight percent of GPPS, from about 55 weight percent to about 70 weight percent of SBC, and from about 0 weight percent to about 15 weight percent of HIPS.

The GPPS may include standard grades of GPPS.

The top and bottom layer may have a thickness between about 0.040 inches and about 0.0512 inches.

The top and bottom layer may have a thickness of less than about 0.040 inches.

The top and bottom layer may have a thickness of greater than about 0.0512 inches.

The polystyrene copolymer blend product having 0.040 inches of thickness may include a haze/clarity property of around 0 to 70 in sheet haze. The polystyrene copolymer blend product may include a preferable haze value under 10.0, 6.0, and 2.0.

The polystyrene copolymer blend product having 0.040 inches of thickness may include around 0 to 30 in sheet haze. The polystyrene copolymer blend product may include a preferable haze value under 10.0, 6.0, and 2.0.

In an example of this disclosure, polystyrene copolymer blend product may include a second layer of about 25 weight percent to about 35 weight percent of GPPS, from about 55 weight percent to about 65 weight percent of SBC, and from about 5 weight percent to about 15 weight percent of HIPS.

In another example of this disclosure, polystyrene copolymer blend product may include a second layer of about 30 weight percent of GPPS, about 60 weight percent of SBC, and about 10 weight percent of HIPS.

The second layer may include a specific range of about 30 weight percent to about 40 weight percent of GPPS, from about 55 weight percent to about 65 weight percent of SBC, and from about 0 weight percent to 10 weight percent of HIPS.

The polystyrene copolymer blend product may include a food package.

The polystyrene copolymer blend product may include one of: an appliance housing, a household accessory, and a medical device.

In another example of this disclosure, polystyrene copolymer blend product may include a second layer of (a) from about 60 weight percent to about 70 weight percent of SBC, (b) from about 23 weight percent to about 33 weight percent of GPPS, and (c) from about 2 weight percent to about 12 weight percent of HIPS.

In yet another example of this disclosure, polystyrene copolymer blend product may include a second layer of preferably 65 weight percent of SBC, preferably about 28 percent of GPPS, and preferably about 7 weight percent of HIPS.

According to another aspect of this disclosure, a process of manufacturing a polystyrene copolymer blend product is provided. The process includes: overlaying a first layer with a second layer; and applying a standard processing method for thermoplastics, wherein the overlaying includes: extruding a first layer that includes about 2 weight percent to about 6 weight percent of a total weight of the product; and extruding a second layer that includes about 98 weight percent to about 94 weight percent of the total weight of the product, wherein the first layer includes about 95 weight percent to about 100 weight percent of GPPS or HIPS, and wherein the second layer includes about 23 weight percent to about 40 weight percent of GPPS, from about 55 weight percent to about 70 weight percent of SBC, and from about 0 weight percent to about 15 weight percent of HIPS.

The standard processing method for thermoplastics may further include one or more of: brown film, extrusion blow moulding, extrusion profiles and sheet, and injection moulding including gas assisted.

The second layer may include from about 25 weight percent to about 35 weight percent of GPPS, from about 55 weight percent to about 65 weight percent of SBC, and from about 5 weight percent to about 15 weight percent of HIPS.

A specific range of the copolymer blend for the second layer may include about 30 weight percent to about 40 weight percent of GPPS, from about 55 weight percent to about 65 weight percent of SBC, and from about 0 weight percent to 10 weight percent of HIPS.

The second layer may include (a) from about 60 weight percent to about 70 weight percent of SBC, (b) from about 23 weight percent to about 33 weight percent of GPPS, and (c) from about 2 weight percent to about 12 weight percent of HIPS.

The second layer may include preferably 65 weight percent of SBC, preferably about 28 percent of GPPS, and preferably about 7 weight percent of HIPS.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a polystyrene copolymer structure, according to the principles of the disclosure.

FIG. 2 shows another example of a polystyrene copolymer structure, according to the principles of the disclosure.

FIG. 3 shows an example of a polystyrene copolymer blend, according to the principles of the disclosure.

FIG. 4 shows another example of a polystyrene copolymer blend, according to the principles of the disclosure.

FIG. 5 shows yet another example of a polystyrene copolymer blend, according to the principles of the disclosure.

FIG. 6 shows an example of a process for creating a polystyrene copolymer blend, according to the principles of the disclosure.

### DETAILED DESCRIPTION OF THE DRAWINGS

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

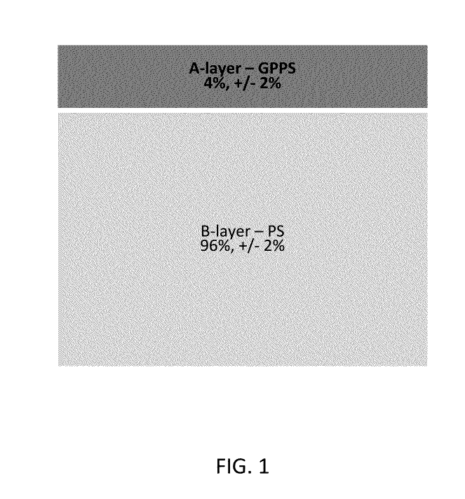

FIG. 1 shows an example of a polystyrene copolymer structure according to the present disclosure. The structure includes a blend of at least one top layer and at least one bottom layer. The top layer may be a first layer and the bottom layer may be a second layer. The top layer includes about 4 percent±about 2 percent general purpose polystyrene (GPPS). The bottom layer includes about 96 percent±about 2 percent polystyrene (PS). The combined thickness of the top and bottom layers may be between about 0.040 inches and about 0.0512 inches. The combined thickness may be greater than 0.0512 inches, or less than 0.040 inches.

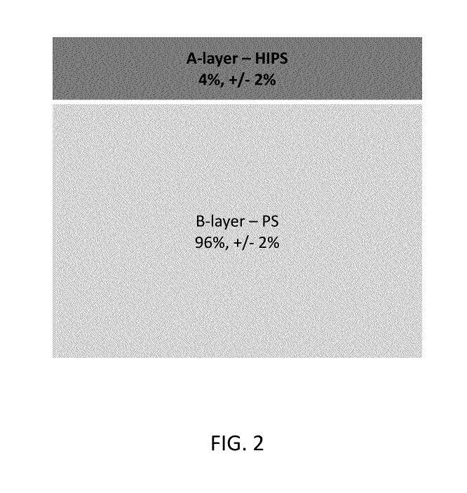

FIG. 2 shows another example of a polystyrene copolymer structure according to the present disclosure. The structure includes a blend of at least one top layer and at least one bottom layer. The top layer includes about 4 percent±about 2 percent high impact polystyrene (HIPS). The bottom layer includes about 96 percent±about 2 percent polystyrene (PS). The combined thickness of the top and bottom layers may be between about 0.040 inches and about 0.0512 inches. The combined thickness may be greater than 0.0512 inches, or less than 0.040 inches.

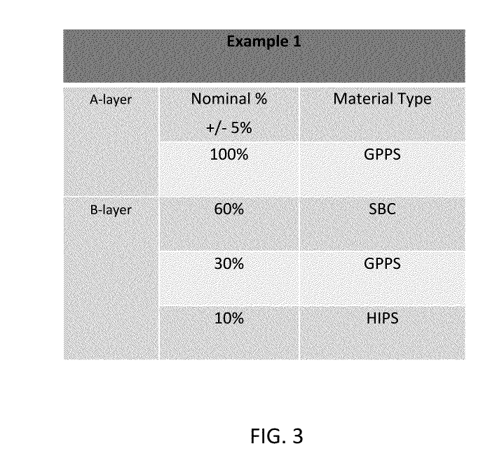

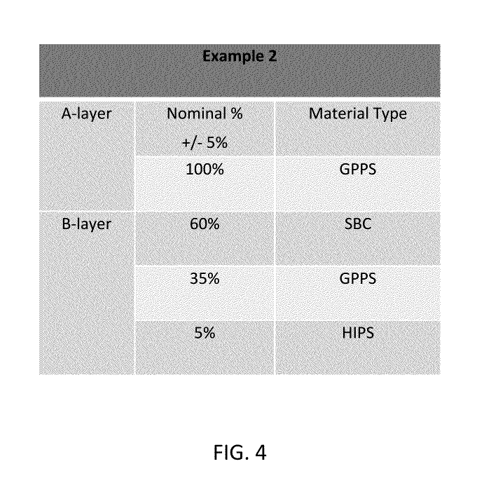

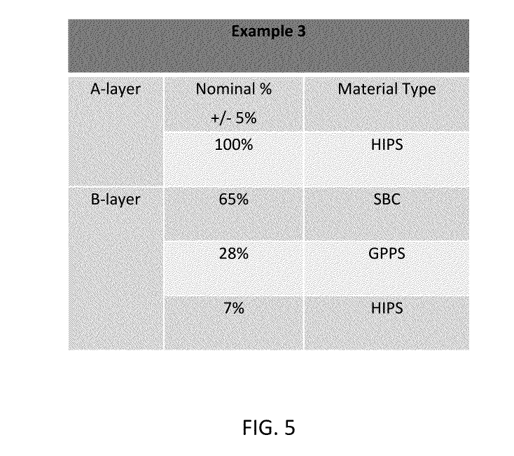

FIGS. 3-5 show examples of the polystyrene copolymer blend according to the present disclosure. The polystyrene copolymer blend may include general purpose polystyrene (GPPS), which may include any standard grade, such as, e.g., 1200/1201, 1290/1291, 1300/1301, 2600/2601, 2610, 3100, 585, 529, 535, 525, 500, and so on.

The polystyrene copolymer blend may include styrene butadiene copolymer (SBC), which may include any standard grade, such as, e.g., 684D, 3G55, 3G46, 2G66, and so on.

The polystyrene copolymer blend may include high impact polystyrene (HIPS), which may include any standard grade, such as, e.g., 5300, 5310, 5400/5401, 5410, 6200/6201, 6210/6211, 6220, 7120, 7800, 844E, 845E, 935E, 940E, 975E, 825E, 945E, 960E, EB/EC6400, EB/EC6600, Styron 421, Styron 484, and so on.

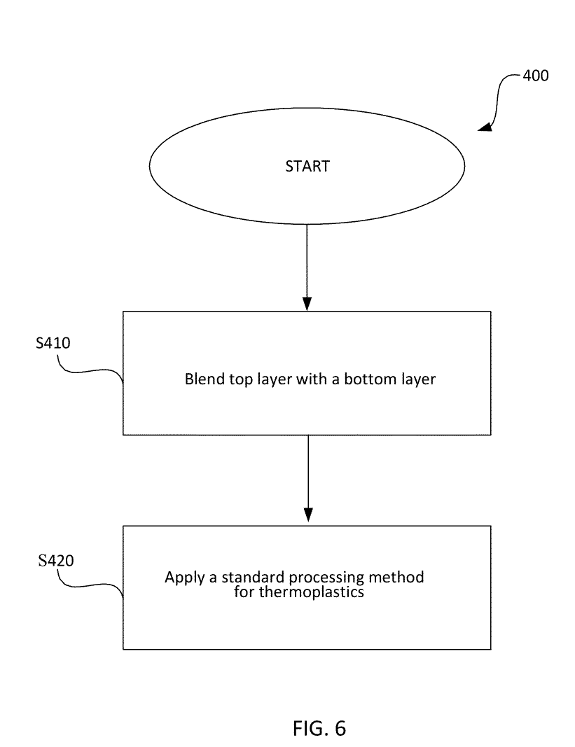

FIG. 6 discloses an example of a process 400 for manufacturing a polystyrene copolymer blend in accordance with the present disclosure. At S410, the process includes extruding (or carrying out an extrusion process on) a first layer that includes about 2 weight percent to about 6 weight percent of a total weight of the copolymer, wherein the layer may include about 100 percent (+/−5 percent) of a standard grade general purpose polystyrene (GPPS). Alternatively, the first layer may include about 100 percent (+/−5 percent) of standard grade high impact polystyrene (HIPS). At S420, the process includes extruding (or carrying out the extrusion process on) a second layer that includes about 94 weight percent to about 98 weight percent of a total weight of the copolymer, wherein the second layer may include polystyrene.

At S420, the process of extruding (or carrying out the extrusion process on) the second layer may include providing about 55 weight percent to about 70 weight percent (preferably between about 60 weight percent and about 65 percent) of styrene butadiene copolymer (SBC), about 25 weight percent to about 40 weight percent (preferably between 28 and 35 percent) of general purpose polystyrene (GPPS), and about 0 weight percent to about 15 weight percent (preferably between about 5 and 10 percent) of high impact polystyrene (HIPS). Alternatively, if the first layer includes about 100 weight percent of HIPS, the second layer may include providing about 60 weight percent to about 70 weight percent (preferably about 65 percent) of SBC, about 23 weight percent to about 33 weight percent (preferably about 28 percent) of GPPS, and about 2 weight percent to about 12 weight percent (preferably about 7 percent) of HIPS.

The process 400 may include any standard processing method for processing thermoplastics, including, brown film, extrusion blow moulding, extrusion profiles and sheet, injection moulding including gas assisted, and so on.

The process 400 may further include forming a product with the first and second layers, where the product has a predetermined thickness. The predetermined thickness may be between about 0.040 inches and about 0.0512 inches. The predetermined thickness may be less than about 0.040 inches. The predetermined thickness may be greater than about 0.0512 inches. The predetermined thickness may vary based on one or more of a sheet thickness, a final part design, an end product requirement, and the like.

The polystyrene copolymer blends of the present disclosure have low haze/high transparency with high strength/high stiffness compared to conventional polystyrene blends. The blends also do not have a noticeable odor, which is an important organoleptic characteristic that is often missing in other polystyrene blends. The copolymer may be suitable in applications that require clear and tough parts, such as, e.g., manufacture of appliance housings, household accessories, medical parts, food containers, and so on.

### EXAMPLE 1

A non-limiting example of a polystyrene copolymer blend product that is created according to the principles of the disclosure is shown in Table 1. This blend product includes (1) at least one top layer including about 2 weight percent to about 6 weight percent of the blend product, wherein the top layer includes about 100 weight percent (+/− about 5 percent) of standard grades of GPPS and (2) at least one bottom layer including about 94 weight percent to about 98 weight percent of the blend product, wherein the bottom layer, in comparison to the entire blend product may include (a) from about 55 weight percent to about 65 weight percent of SBC, (b) from about 25 weight percent to about 35 weight percent of GPPS, and (c) from about 5 weight percent to about 15 weight percent of HIPS.

TABLE 1

| | | | | percent | | percent |
|---|---|---|---|---|---|---|
| | | | percent | (wt.) | percent | (wt.) |
| | percent (wt.) | percent (wt.) | (wt.) | GPPS in | (wt.) SBC | HIPS in |
| | top layer in | bottom layer | GPPS in | bottom | in bottom | bottom |
| FORMULATION | copolymer | in copolymer | top layer | layer | layer | layer |
| Preferred Blend | 4 | 96 | 100 | 30 | 60 | 10 |
| Specific Range | 2-6 | 94-98 | 95-100 | 25-35 | 55-65 | 5-15 |
| Broad Range | 2-6 | 94-98 | 95-100 | 23-40 | 55-70 | 0-15 |

As shown in Table 1 above, the preferred copolymer structure includes about 4 weight percent for the top layer and about 96 weight percent for the bottom layer. The broad range for the top layer of the copolymer blend includes about 2 weight percent to about 6 weight percent of a total weight of the blend. The broad range for the bottom layer of the copolymer blend includes about 94 weight percent to about 98 weight percent of the total weight of the blend.

The preferred copolymer blend may include about 100 weight percent of GPPS in the top layer. The broad range of the copolymer blend for the top layer may include about 95 weight percent to about 100 weight percent of GPPS.

For the bottom layer, the preferred copolymer blend may include about 30 weight percent of GPPS, about 60 weight percent of SBC, and about 10 weight percent of HIPS.

The broad range of the copolymer blend for the bottom layer may include from about 23 weight percent to about 40 weight percent of GPPS, from about 55 weight percent to about 70 weight percent of SBC, and from about 0 weight percent to about 15 weight percent of HIPS.

The specific range of the copolymer blend for the bottom layer may include from about 25 weight percent to about 35 weight percent of GPPS, from about 55 weight percent to about 65 weight percent of SBC, and from about 5 weight percent to about 15 weight percent of HIPS.

This copolymer blend results in improved haze/clarity properties with enhanced toughness and stiffness. The haze values from the example 1 of the present disclosure are listed in Table 2 below. The minimum target may be 0 and the maximum target may vary as a function of thickness. The values are listed based on thickness of 0.040″ and 0.051″.

TABLE 2

| Property | Value |
|---|---|
| Sheet haze, 0.040″ | 56.2 |
| Minimum haze, 0.040″ | 0.0 |
| Maximum haze, 0.040″ | 70.0 |
| Sheet haze, 0.051″ | 74.2 |
| Minimum haze, 0.051″ | 0.0 |
| Maximum haze, 0.051″ | 80.0 |

### EXAMPLE 2

Another non-limiting example of a polystyrene copolymer that is created according to the principles of the disclosure is shown in Table 3. This blend includes (1) a top layer including about 2 weight percent to about 6 weight percent of a total weight of the copolymer, wherein the top layer may include about 95 weight percent to about 100 weight percent (preferably about 100 percent) of standard grades of GPPS, and (2) a bottom layer including about 94 weight percent to about 98 weight percent of the total weight of the copolymer, wherein the bottom layer includes (a) from about 55 weight percent to about 65 weight percent (preferably 60 percent) of SBC, (b) from about 30 weight percent to about 40 weight percent (preferably about 35 percent) of GPPS, and (c) from about 0 weight percent to about 10 weight percent (preferably about 5 percent) of HIPS.

TABLE 3

| | | | | | percent | percent |
|---|---|---|---|---|---|---|
| | percent | | percent | percent | (wt.) | (wt.) |
| | (wt.) | percent (wt.) | (wt.) | (wt.) GPPS | SBC in | HIPS in |
| | top layer in | bottom layer | GPPS in | in bottom | bottom | bottom |
| FORMULATION | copolymer | in copolymer | top layer | layer | layer | layer |
| Preferred Blend | 4 | 96 | 100 | 35 | 60 | 5 |
| Specific Range | 2-6 | 94-98 | 100 | 30-40 | 55-65 | 0-10 |
| Broad Range | 2-6 | 94-98 | 95-100 | 23-40 | 55-70 | 0-15 |

As shown in Table 3 above, the preferred copolymer blend includes about 4 weight percent of a total weight percent of the blend for the top layer and about 96 weight percent of the total weight of the blend for the bottom layer. The broad range for the top layer of the copolymer blend includes about 2 weight percent to about 6 weight percent of the total weight of the blend. The broad range for the bottom layer of the copolymer blend includes about 94 weight percent to about 98 weight percent of the total weight of the blend.

The preferred copolymer blend may include about 100 weight percent of GPPS in the top layer. The broad range of the copolymer blend for the top layer may include from about 95 weight percent to about 100 weight percent of GPPS. For the bottom layer, the preferred copolymer blend may include about 35 weight percent of GPPS, about 60 weight percent of SBC, and about 5 weight percent of HIPS. The broad range of the copolymer blend for the bottom layer may include from about 23 weight percent to about 40 weight percent of GPPS, from about 55 weight percent to about 70 weight percent of SBC, and from about 0 to 15 weight percent of HIPS.

The specific range of the copolymer blend for the bottom layer may include about 30 to about 40 weight percent of GPPS, from about 55 weight percent to about 65 weight percent of SBC, and from about 0 weight percent to 10 weight percent of HIPS.

This copolymer blend results in improved haze/clarity properties with enhanced toughness and stiffness. The haze values from the example 2 of the present disclosure are listed in Table 5 below. The minimum target may be 0 and the maximum target may vary as a function of thickness. The values are listed based on thickness of 0.040″ and 0.051″.

TABLE 4

| Property | Value |
|---|---|
| Sheet haze, 0.040″ | 27.9 |
| Minimum haze, 0.040″ | 0.0 |
| Maximum haze, 0.040″ | 40.0 |
| Sheet haze, 0.051″ | 40.0 |
| Minimum haze, 0.051″ | 0.0 |
| Maximum haze, 0.051″ | 50.0 |

### EXAMPLE 3

Another non-limiting example of a polystyrene copolymer blend product that is created according to the principles of the disclosure is shown in Table 5. This blend product includes (1) a top layer including about 2 weight percent to about 6 weight percent of a total weight of the copolymer, wherein the top layer may include about 95 weight percent to about 100 weight percent (preferably about 100 percent) of standard grades of HIPS, and (2) a bottom layer including about 94 weight percent to about 98 weight percent of the total weight of the copolymer, wherein the bottom layer includes (a) from about 60 weight percent to about 70 weight percent (preferably 65 percent) of SBC, (b) from about 23 weight percent to about 33 weight percent (preferably about 28 percent) of GPPS, and (c) from about 2 weight percent to about 12 weight percent (preferably about 7 percent) of HIPS.

TABLE 5

| | | percent | | | | percent |
|---|---|---|---|---|---|---|
| | | (wt.) | percent | percent | percent | (wt.) |
| | percent (wt.) | bottom | (wt.) HIPS | (wt.) GPPS | (wt.) SBC | HIPS in |
| | top layer in | layer in | in top | in bottom | in bottom | bottom |
| FORMULATION | copolymer | copolymer | layer | layer | layer | layer |
| Preferred Blend | 4 | 96 | 100 | 28 | 65 | 7 |
| Specific Range | 2-6 | 94-98 | 100 | 23-33 | 60-70 | 2-12 |
| Broad Range | 2-6 | 94-98 | 95-100 | 23-40 | 55-70 | 0-15 |

As shown in Table 5 above, the preferred copolymer structure includes about 4 weight percent of a total weight of the structure for the top layer and about 96 weight percent of the total weight of the structure for the bottom layer. The broad range for the top layer of the copolymer blend includes about 2 weight percent to about 6 weight percent of the copolymer blend. The broad range for the bottom layer of the copolymer blend includes about 94 weight percent to about 98 weight percent of the copolymer blend.

The preferred copolymer blend may include about 100 weight percent of HIPS in the top layer. The broad range of the copolymer blend for the top layer may include from about 95 weight percent to about 100 weight percent of HIPS. For the bottom layer, the preferred copolymer blend may include about 28 weight percent of GPPS, about 65 weight percent of SBC, and about 7 weight percent of HIPS. The broad range of the copolymer blend for the bottom layer may include from about 23 weight percent to about 40 weight percent of GPPS, from about 55 weight percent to about 70 weight percent of SBC, and from about 0 weight percent to 15 weight percent of HIPS.

The specific range of the copolymer blend for the bottom layer may include about 23 weight percent to about 33 weight percent of GPPS, from about 60 weight percent to about 70 weight percent of SBC, and from about 2 weight percent to 12 weight percent of HIPS.

This copolymer blend results in improved haze/clarity properties with enhanced toughness and stiffness. The haze values from the example 2 of the present disclosure are listed in Table 6 below. The minimum target may be 0 and the maximum target may vary as a function of thickness. The values are listed based on thickness of 0.040″ and 0.051″.

TABLE 6

| Property | Value |
|---|---|
| Sheet haze, 0.040″ | 16.4 |
| Minimum haze, 0.040″ | 0.0 |
| Maximum haze, 0.040″ | 30 |
| Sheet haze, 0.051″ | N/A |
| Minimum haze, 0.051″ | N/A |
| Maximum haze, 0.051″ | N/A |

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

The term “about”, as used in this disclosure, means plus or minus ten percent range.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single layer or article is described herein, it will be readily apparent that more than one layer or article may be used in place of a single layer or article. The functionality or the features of a layer or article may be alternatively embodied by one or more other layers or articles which are not explicitly described as having such functionality or features.

What is claimed is:

1. A polystyrene copolymer blend product, comprising:
a first layer comprising about 2 weight percent to about 6 weight percent of a total weight of the product; and
a second layer comprising about 98 weight percent to about 94 weight percent of the total weight of the product,
wherein the first layer further comprises about 95 weight percent to about 100 weight percent of GPPS or HIPS, and
wherein the second layer further comprises about 23 weight percent to about 40 weight percent of GPPS, from about 55 weight percent to about 70 weight percent percent of SBC, and from about 0 to about 15 weight percent of HIPS.

2. The product of claim 1, wherein the GPPS comprises standard grades of GPPS.

3. The product of claim 1, wherein the product comprises a thickness between about 0.040 inches and about 0.0512 inches.

4. The product of claim 1, wherein the product comprises a thickness of less than about 0.040 inches.

5. The product of claim 1, wherein the product comprises a thickness of greater than about 0.0512 inches.

6. The product of claim 1, wherein a haze/clarity property of the product having 0.040 inches of thickness comprises around 0 to 70 in sheet haze.

7. The product of claim 12, wherein a haze/clarity property of the product having 0.040 inches of thickness further comprises around 0 to 30 in sheet haze.

8. The product of claim 1, wherein the second layer may include from about 25 weight percent to about 35 weight percent of GPPS, from about 55 to about 65 weight percent of SBC, and from about 5 to about 15 weight percent of HIPS.

9. The product of claim 1, wherein the second layer includes about 30 weight percent of GPPS, about 60 weight percent of SBC, and about 10 weight percent of HIPS.

10. The product of claim 1, wherein a specific range of the copolymer blend for the second layer comprises about 30 weight percent to about 40 weight percent of GPPS, from about 55 weight percent to about 65 weight percent of SBC, and from about 0 weight percent to 10 weight percent of HIPS.

11. The product of claim 1, wherein the product comprises a food package.

12. The product of claim 1, wherein the product comprises one of: an appliance housing, a household accessory, and a medical device.

13. The product of claim 1, wherein the second layer comprises (a) from about 60 weight percent to about 70 weight percent of SBC, (b) from about 23 weight percent to about 33 weight percent of GPPS, and (c) from about 2 weight percent to about 12 weight percent of HIPS.

14. The product of claim 13, wherein the second layer further comprises preferably 65 weight percent of SBC, preferably about 28 percent of GPPS, and preferably about 7 weight percent of HIPS.

15. A process of manufacturing a polystyrene copolymer blend product comprising:
overlaying a first layer with a second layer; and
applying a standard processing method for thermoplastics,
wherein the overlaying comprises:
extruding a first layer that comprises about 2 weight percent to about 6 weight percent of a total weight of the product; and
extruding a second layer the comprises about 98 weight percent to about 94 weight percent of the total weight of the product;
wherein the first layer comprises about 95 weight percent to about 100 weight percent of GPPS or HIPS, and
wherein the second layer comprises about 23 weight percent to about 40 weight percent of GPPS, from about 55 weight percent to about 70 weight percent of SBC, and from about 0 weight percent to about 15 weight percent of HIPS.

16. The process of claim 15, wherein the standard processing method for thermoplastics further comprises one or more of: brown film, extrusion blow moulding, extrusion profiles and sheet, and injection moulding including gas assisted.

17. The process of claim 15, wherein the second layer may include from about 25 weight percent to about 35 weight percent of GPPS, from about 55 weight percent to about 65 weight percent of SBC, and from about 5 weight percent to about 15 weight percent of HIPS.

18. The process of claim 15, wherein a specific range of the copolymer blend for the second layer comprises about 30 weight percent to about 40 weight percent of GPPS, from about 55 weight percent to about 65 weight percent of SBC, and from about 0 weight percent to 10 weight percent of HIPS.

19. The process of claim 15, wherein the second layer comprises (a) from about 60 weight percent to about 70 weight percent of SBC, (b) from about 23 weight percent to about 33 weight percent of GPPS, and (c) from about 2 weight percent to about 12 weight percent of HIPS.

20. The process of claim 19, wherein the second layer further comprises preferably 65 weight percent of SBC, preferably about 28 percent of GPPS, and preferably about 7 weight percent of HIPS.
